(19) United States
(12) Patent Application Publication
(10) Pub. No.: US 2014/0252914 A1
(43) Pub. Date: Sep. 11, 2014

(54) ELECTROSTATIC GENERATOR/MOTOR DESIGNS CAPABLE OF OPERATION WITH THE ELECTRODES IMMERSED IN A LIQUID OR PRESSURIZED GAS

(71) Applicant: LAWRENCE LIVERMORE NATIONAL SECURITY, LLC, LIVERMORE, CA (US)

(72) Inventor: Richard F. Post, Walnut Creek, CA (US)

(73) Assignee: LAWRENCE LIVERMORE NATIONAL SECURITY, LLC, LIVERMORE, CA (US)

(21) Appl. No.: 14/198,538

(22) Filed: Mar. 5, 2014

Related U.S. Application Data
(60) Provisional application No. 61/773,527, filed on Mar. 6, 2013.

(51) Int. Cl. H02N 1/00

(52) U.S. Cl. CPC H02N 1/006
USPC 310/309

(57) ABSTRACT

Electrostatic generator/motor electrode assembly designs are provided that both minimize the rotor drag forces and increase the power output relative to older designs. In one of the new designs, both the rotor and the stator electrodes are encapsulated in a dielectric that forms smooth surface discs or cylinders that result in minimal fluid drag losses on the rotors and also increases the voltage-breakdown potentials between the rotor and stator elements. In the second of the new designs, the disc or cylinder geometry is maintained for both rotor and stator but the rotor has no embedded electrodes. Instead it is made up of an assembly of dielectric elements that alternate between a high dielectric constant and a low dielectric constant forming a smooth surface disc of surface.

### CROSS-REFERENCE TO RELATED APPLICATIONS

This application claims the benefit of U.S. Provisional Patent Application No. 61/773,527 titled “Improved Electrostatic Generator/Motor Designs Capable of Operation With the Electrodes Immersed In a Liquid or Pressurized Gas,” filed Mar. 6, 2013, incorporated herein by reference.

### STATEMENT REGARDING FEDERALLY SPONSORED RESEARCH OR DEVELOPMENT

The United States Government has rights in this invention pursuant to Contract No. DE-AC52-07NA27344 between the U.S. Department of Energy and Lawrence Livermore National Security, LLC, for the operation of Lawrence Livermore National Laboratory.

### BACKGROUND OF THE INVENTION

1. Field of the Invention

The present invention relates to electrostatic generator/motors, and more specifically, it relates to the operation of such devices in a liquid or gaseous environment.

2. Description of Related Art

Electrostatic generator/motors, for example those of the types described in U.S. Pat. No. 7,834,513, incorporated herein by reference, are typically operated in a vacuum environment, as is required when the generator/motor is integrated with a high speed flywheel rotor spinning at tens of thousands of revolutions per minute. In such cases the vacuum environment performs two functions. First, it reduces to near-zero the aerodynamic drag losses that would otherwise occur, and, second, it suppresses electrical breakdown between the charged electrodes so that the high charging potentials required for high-power operation can be employed. There are, however, other potential uses for these electrostatic generator/motors where it would be very advantageous to operate the electrodes in a liquid or gaseous environment that is capable of providing the necessary control of high-potential voltage-breakdown. New electrostatic generator/motor designs are desired that specifically address the practical problems that such an environment poses.

### SUMMARY OF THE INVENTION

This invention addresses the problems encountered for electrostatic generator/motors when their electrodes are operated in a liquid or pressurized gas environment instead of in a vacuum. It involves new designs for the electrode assembly that both minimize the drag forces on their rotors and increase the power output relative to older designs. In one of the new designs, both the rotor and the stator electrodes are encapsulated in a dielectric (e.g., plastic) that forms smooth surface discs that result in minimal fluid drag losses on the rotors and also increase the voltage-breakdown potentials between the rotor and stator elements. In the second of the new designs, the disc geometry is maintained for both rotor and stator but the rotor has no embedded electrodes. Instead it is made up of an assembly of (e.g., narrow pie-slice-shaped) dielectric (e.g., plastic) elements that alternate between a high dielectric constant and a low dielectric constant forming a smooth surface disc of surface. The rotor-stator capacitor now is made up of the following elements. In the first stator disc, embedded metallic electrodes (which may be planar with rounded edges or flattened ellipses), and next, (unless the electrode surface fits smoothly onto the surface of the stator disc) comes the plastic material that forms the stator discs. Next, the stator disc surface is immersed in a dielectric fluid (e.g., transformer oil) that fills the gap between the stator and rotor disc surfaces. Next comes the variable-dielectric rotor disc, then another fluid-filled gap and, finally, the face of another stator disc. This pattern is repeated down the length of the generator. In this way the stator-rotor-stator capacitor assembly generates a time-varying capacity under rotation.

### BRIEF DESCRIPTION OF THE DRAWINGS

The accompanying drawings, which are incorporated into and form a part of the disclosure, illustrate embodiments of the invention and, together with the description, serve to explain the principles of the invention.

FIG. 1A shows a schematic drawing of a rotor spoke assembly.

FIG. 1B shows a view of an embedded electrode

FIG. 2A shows a schematic drawing of a stator spoke assembly.

FIG. 2B shows a stacked arrangement of two cells of stacked rotors and stators utilizing the rotors of FIG. 1A and the stators of FIG. 2A.

FIG. 3A shows a schematic drawing of a rotor disc with alternating high and low dielectric sections where the high dielectric constant sections are shown shaded and the low dielectric constant sections are shown without shading.

FIG. 3B shows a stacked arrangement of two cells of stacked rotors and stators utilizing the rotors of FIG. 1A and the stators of FIG. 3A.

FIG. 4 shows calculated normalized capacity variation for “pincushion” electrode system.

FIG. 5 shows calculated normalized capacity variation for variable-dielectric-constant electrode system.

FIG. 6 shows an end view of an embodiment of nested metallic cylinder.

### DETAILED DESCRIPTION OF THE INVENTION

An example of an application where the new designs could be employed is a low-rpm generator suitable for direct-drive (or a low-ratio gear-up) for a large wind-power generator system. Here the operating speeds could typically be in the range of 15 to 30 rpm. At these speeds, the drag on the rotor electrode system caused by filling the generator housing vessel with a liquid or a high-pressure gas can be made to be tolerable, provided that the rotor and stator designs are such as to minimize this drag. The new designs presented herein are aimed at accomplishing this objective, while at the same time enhancing the output power over that obtainable from the older designs.

The new designs are improvements on the “pincushion” rotor and stator designs that have been described, e.g., in U.S. Pat. No. 8,264,121, incorporated by reference, U.S. Pat. No. 8,643,249, incorporated by reference, and U.S. patent application Ser. No. 14/171,724, incorporated by reference. In a first embodiment, the “pins” could either be circular in cross-section or elliptical. The invention also offers improvements on the designs provided in U.S. patent application Ser. No. 13/796,678, incorporated herein by reference.

### Version I: Encapsulated Electrodes

In the first version of the new designs both the stator and the rotor pincushion rod assemblies described above are cast within discs made of plastic. The plastic is chosen to have good voltage-holding properties and adequate mechanical strength. The discs could have a thickness equal to or greater than the diameter (in the axial direction) of the rods, depending on a detailed analysis and optimization of the electrical properties of the rotor-stator system, including the choice of dielectric constant of the plastic. In any event, the outer surfaces of all of the discs needs to be smooth and planar. When this is the case, the viscous drag force will be minimized, being very much lower than the drag that would be caused if there were no such enclosure around the electrodes. In addition, the mechanical rigidity of a cell against axial displacements will be much greater than that of unsupported electrodes, thus allowing a smaller gap between the rotor and stator electrode assemblies.

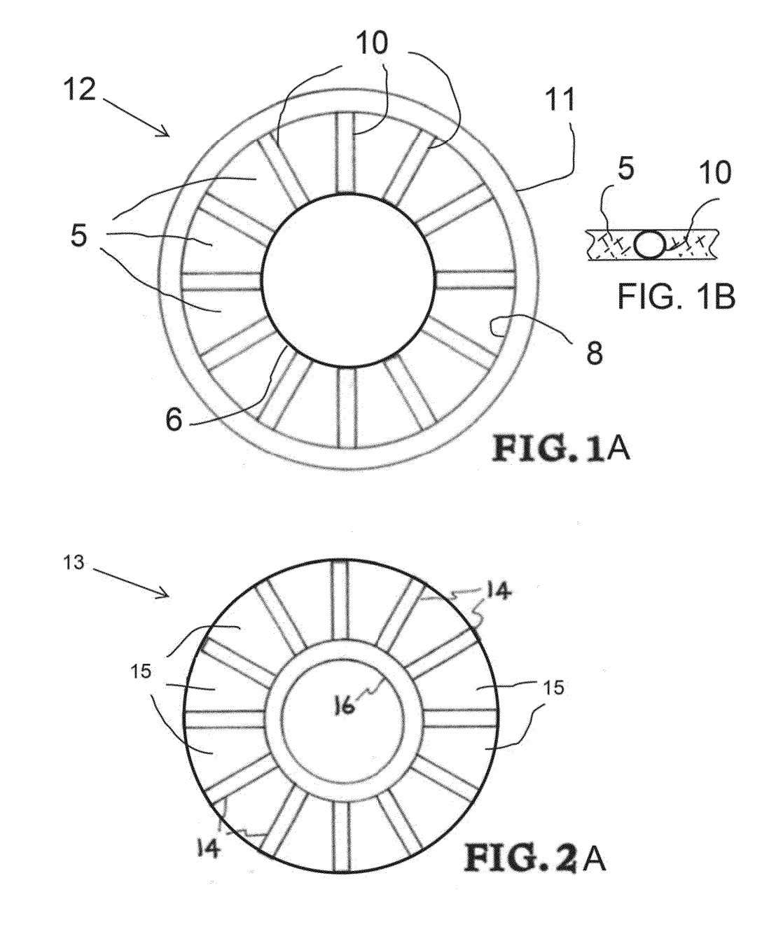

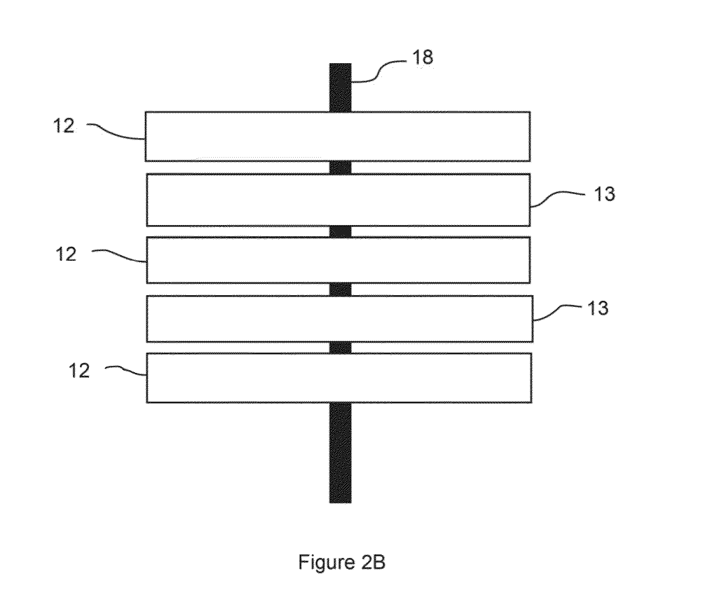

FIG. 1A shows a view of a stator 12 with electrodes 10 supported with a ring 11. The electrodes are encased in a dielectric material 5, the inner edge of which is represented by reference number 6 and the outer edge of which is represented by reference number 8. The concept is that the electrodes are embedded in a material such that the entire stator has the form of a disc with relatively flat major surfaces. FIG. 1B shows a view (from the center of the stator toward the outer edge) of a single electrode 10 embedded in dielectric material 5. FIG. 2A shows a view of a rotor 13 with electrodes 14 attached to a central large-diameter shaft 16. Like the stator electrodes, all of the rotor electrodes are encased in a dielectric material 15. The stator can be supported from the inside or the outside as can the rotor. A side view of a single cell would show a single rotor with a stator electrode assembly on each side of the rotor. In a complete system a “cell” would consist of a rotor assembly and two stator assemblies. Each stator assembly can operate with its back half forming the stator electrodes for an adjacent cell. FIG. 2B shows an assembly with two cells. Along a central axis 18 are centered three stators 12 and two rotors 13 as described above and shown in FIGS. 1A and 2A respectively. It will be understood by those skilled in the art based on the teachings herein that the elements can be supported in various ways, including those ways described in the incorporated patents and application. Notice that the surfaces between each disc are relatively smooth. If the rotor electrodes were not encased, then as they rotate in a viscous medium or in a gas, turbulence would be generated which would increase the drag that the rotor would encounter. If only the rotor electrodes are encased and not the stator electrodes, such a device would still offer improved operation over a device that did not have encased rotor electrodes; however, the overall system will operate much better if the stator electrodes are also encased. Note that although the rotor and stator electrodes are shown to have a circular cross-section, they can also have other cross-sectional areas such a elliptical or planar with rounded edges.

Version II: Rotor Assembly with Variable Dielectric Constant

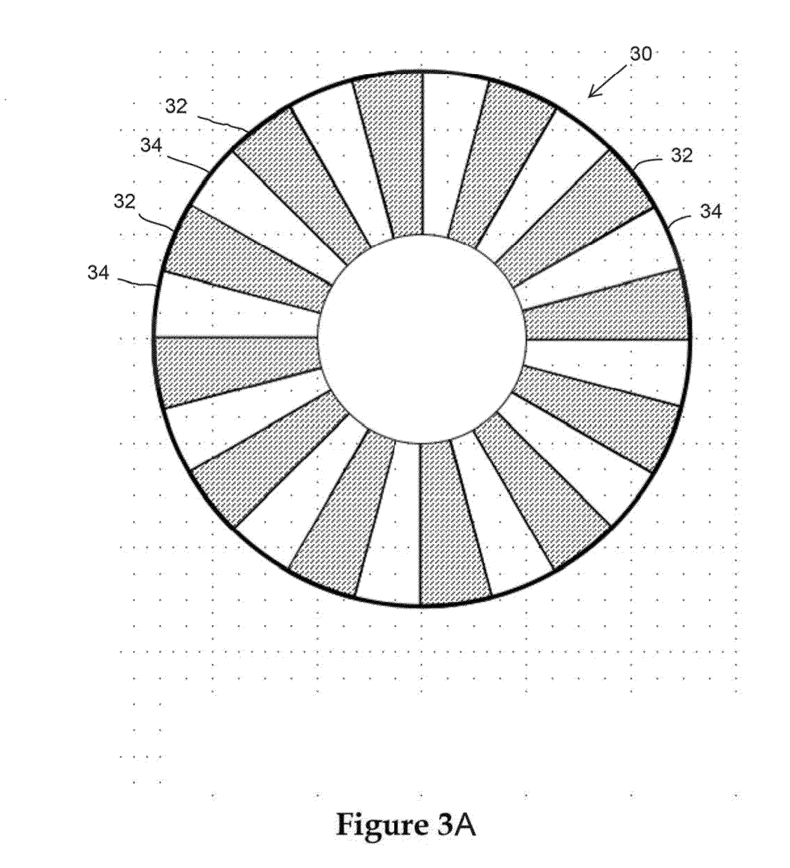

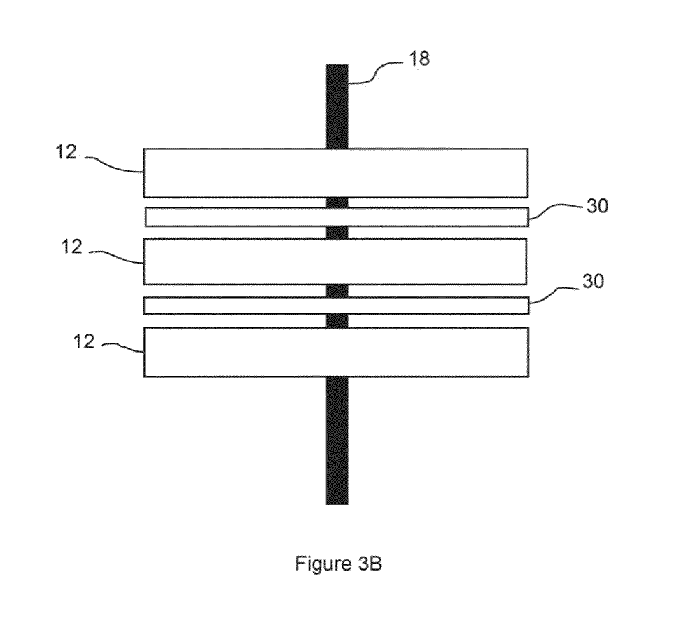

The second version of the designs also has its stator electrodes (which would preferably be ellipses or planar electrodes with rounded edges) cast within a plastic to form smooth-surface discs. The stators can take a form similar or identical to the form shown in FIG. 1A. However, the rotor is to be made entirely of plastic, with no embedded metallic electrodes. As shown in FIG. 3A, here the concept is to construct a disc 30 that is made of an alternating assembly of wedge-shaped sections 32, 34 made of two different types of plastic, half of them having a low dielectric constant, and half having a substantially higher dielectric constant. The periodicity of the alternation of types is to be the same as that of the stator electrodes. Now the periodic alternation of capacity required for generator or motor action arises from the space-averaged dielectric constant of the media between the stator electrodes between which the rotor disc is situated. With care in the design both higher average capacities and higher max/min ratios of the capacity can be achieved than is possible with metallic electrodes alone. Both of these parameters contribute to the power output obtainable from a given total volume of electrode assemblies. The enhancing effect is further increased if the entire electrode system is immersed in an insulating liquid (e.g. transformer oil) having a dielectric constant comparable to that of the plastics from which the rotor and stator discs are fabricated. FIG. 3B shows an assembly with two cells. Elements in this figure that are identical to the elements of FIG. 2B have the same reference numbers. Along a central axis 18 are centered three stators 12 and two rotors 30 as described above and shown in FIGS. 1A and 3A respectively.

Note that the concept of embedding the electrodes of an electrostatic generator/motor can be carried out in other cell configurations as well. For example, the electrodes can take the form of corrugations as described in the incorporated patents and application. Further, instead of a stacked disc arrangement, a set of concentric cylinders can be utilized as also described in the incorporated patents and application. In the first general type of embodiment described above, the concept is to encase in a dielectric medium all of the electrodes of each rotor and each stator. In the other general embodiment, the rotor does not contain electrodes but instead is formed of alternating sections of high and low dielectric constant material. The number of sections corresponds to the number of electrodes of the stators.

Computer code calculations have been made to illustrate the effectiveness of the alternating dielectric rotor by comparing its performance with that of a “pincushion” rotor. In the example, the size of the generator/motor itself was kept the same, as was the number of rotor/stator electrodes on each disc. Both systems were immersed in FR3 transformer oil, and both were limited to the same maximum voltage across the condensers. The length of the rotor stator system was 10 meters in each case; the diameter was 3 meters, and the operating speed was 30 rpm (appropriate to the use of the generators in a wind-turbine system). For the pincushion system the power output was 4.4 MW and the generator efficiency was 0.981 (as measured at its output terminals, prior to rectification and inversion to 60 Hz). For the variable-dielectric case the output power was 5.5 MW and its efficiency was 0.997.

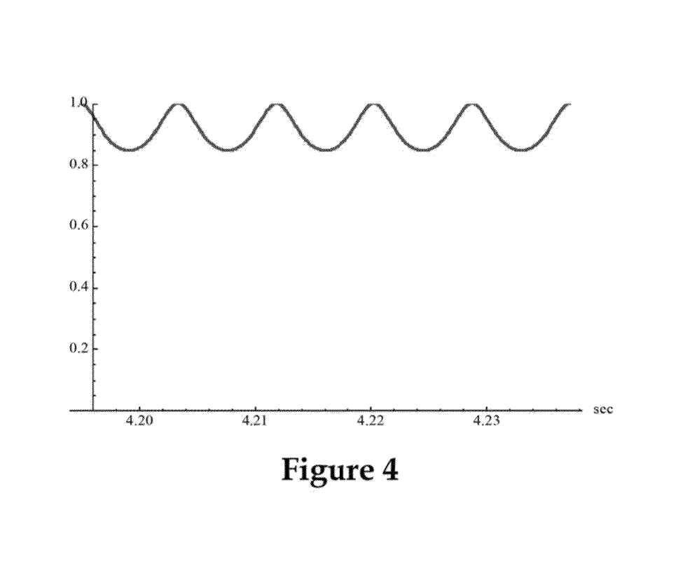

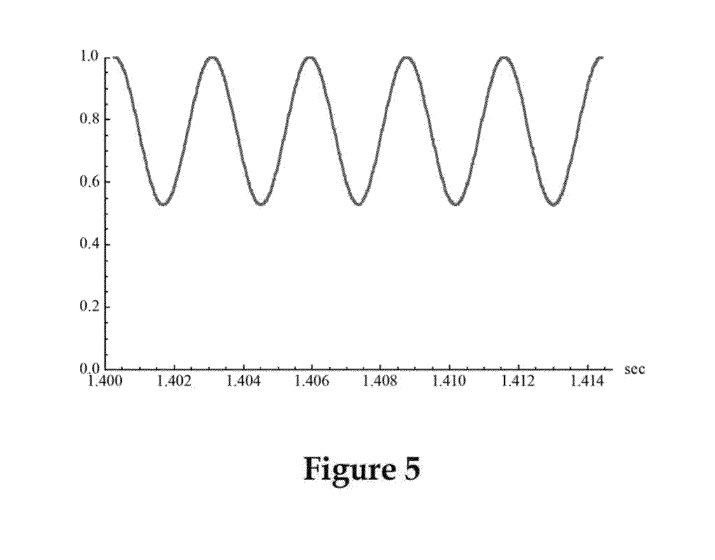

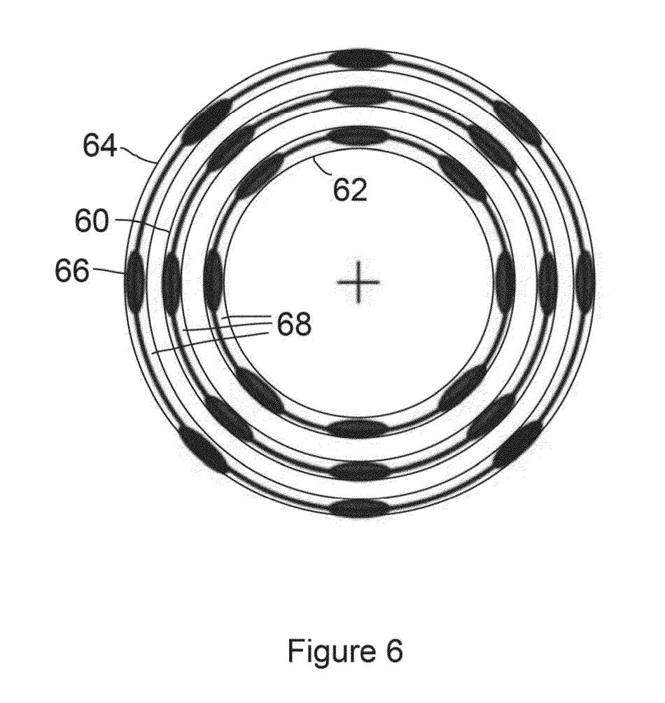

One of the reasons the variable-dielectric system gave better performance than the pincushion system was that the max/min ratio of the capacitance of the former was substantially larger than that of the latter. This difference is shown by the plots of FIGS. 4 and 5, which depict the normalized value of the capacitance as a function of rotation of the two systems.

In addition to the above-cited advantages of the variable-dielectric-constant system it is probable that the latter system can be operated at higher stator-rotor-stator potentials than can the pincushion system, owing to the replacement of metallic elements in the rotor by dielectric material.

FIG. 6 shows an end view of a cylindrical embodiment with a rotor 60, an inner stator 62 and an outer stator 64. The larger and smaller parts of the cylinders shown in the figure can be formed, e.g., from a single metal cylinder. In an actual embodiment, the corners of the thick lands 66 can be rounded to avoid field-enhancement effects that occur at sharp edges in charged conductors. The figure illustrates an embodiment having rounded corners. Alternately, the rotor 60 can be formed of alternating sections relatively high and low dielectric constant material and not include electrodes. In both types of embodiments, the two stators and the rotor are encased in a dielectric material 68 to reduce the drag as the rotor rotates in the gaseous or liquid medium.

### Hydrodynamic Drag Losses for New and Previous Electrode Configurations

Calculations have been made of the hydrodynamic drag of the new configurations as compared to the drag losses of non-shrouded pincushion electrode systems. These calculations show the large reduction in drag that results from casting the electrodes into disc-shaped shrouds. The formula for the drag loss of a rotating disc (the rotor) closely spaced to a stationary disc (the stator) can be calculated from an equation given in the Standard Handbook for Mechanical Engineers (Baumeister and Marks). When expressed in metric units the drag loss is given by the equation below.

$$dpwr = 1.08 * {10}^{- 6} \frac{z * {( rpm )}^{2} ( {od}^{4} - {id}^{4} )}{gap} Watts$$

In the equation, z is the viscosity in centipoise, od (m.) is the outer diameter of the discs, id (m.) is the inner diameter and gap (m.) is the gap between the discs.

The above equation can be used to evaluate the drag losses for the variable dielectric disc example given earlier, using 100° C. Using FR3 transformer oil as the fluid in which the discs are immersed, we have the following values: z=6 centipoise; od=3.0 m.; id=1.5 m.; gap=3 mm and rpm=30. The loss per disc-disc interface is found to be 197 Watts. Thus, the loss per cell is twice this figure. In the example, the number of cells is 714 so that the total viscous drag power is 280 Kw, or 4.2 percent of the output of 5.5 MW.

The above drag power loss can be compared to the losses that would be expected if the rotor consisted of a pincushion of rods having the same length as the difference between the outer and inner diameter of the variable dielectric rotor disc, a diameter equal to the thickness of that rotor, and with the number of rods being the same as the number of high-dielectric segments of that rotor. An estimate based on the approximate drag coefficient of a cylinder moving in a direction perpendicular to its axis gives a drag power loss of a single pincushion disc rotor of 130 kW, a factor of 330 larger than that calculated for a shrouded rotor.

Thus, new rotor and stator configurations for electrostatic generator/motor systems that operate while immersed in an insulating fluid have been described. These new systems both minimize the drag losses on their rotors and also increase the voltage-holding and power output of such generator/motors over that of earlier designs. Among the applications of the new concepts is their use as generators in direct-drive wind-power systems where they would eliminate the need for the high-ratio gear boxes now used to increase the low (15 to 30 rpm) shaft speed of the wind turbine to the speeds required by commercial electromagnetic-type generators.

To maximize the output from electrostatic generator/motor configurations that used disc-shaped stator and rotor structures immersed in an insulating fluid or high-pressure gas environment, it is important to be able to minimize both the axial gaps between the rotor and stator discs as well as to limit their thickness. When the diameter of the discs is large (of order 3 meters for applications such as direct-drive wind-turbine generators) the issue of maintaining the narrow gaps while under operation is an important one. Two methods for accomplishing this end with minimal complication are described below.

The first approach involves the use of magnetic forces to provide a centering action. One embodiment of this approach would involve a ring of thin permanent magnet bars embedded in the structure adjacent to the outer edge of each rotor disc. These magnet bars are polarized in the radial direction and may either form a complete ring or a series of uniformly spaced magnet bars, depending on the magnitude of the centering force required. Immediately inside each ring of magnets is the outer edge of a rotor disc. Embedded in this edge is a ring of magnetic material. This material could either be a narrow strip of magnetically “soft” iron, or it could also be a ring composed of thin magnet bars, polarized radially so that they experience an attractive force from the stationary bar magnet array from which they are separated by a small gap. The width in the axial direction of either the soft iron strips or the bar magnets in the rotor discs would be the same as that of the stationary array of bar magnets, so as maximize the axial stiffness of the magnetic centering effect. A calculation of the magnitude of this stiffness was made for inner and outer magnet rings made from Samarium Cobalt permanent magnet material (Bᵣ=1.3 T). The width and depth of the magnets was 5 mm., as was the radial gap between them. The calculated axial stiffness of this system was approximately 500 Newtons/mm.

The second approach to providing centering action would involve the use of small ball bearings mounted either on the outer surface of the rotor rings or on the stator rings near or at their outer periphery.

When mounted on the rotor the axes of the bearings would be oriented radially. The diameter of the outer bearing race would be perhaps a millimeter or less smaller than the axial separation between the inner faces of the stator discs so that if the system remained centered there would be no contact between the bearing race and either of the two stator discs. However, deviations in excess of the separation gap would bring one or more bearing race into contact with a stator disc and prevent further movement.

When mounted on the stator discs bearing axes would again be directed radially but the mounting shafts would be inserted into holes that were drilled into “cutout” regions on the periphery of the stator discs so that the outer races would be closely adjacent to the faces of the rotor discs near their outer periphery. A similar centering action upon axial displacement of the outer edges of the rotor discs would then occur.

Either or both of the approaches described above for the centering of the rotor discs could be applied to the inner diameter of the stator discs if needed. Magnets and/or a strip of magnetic material could be embedded in the hole in the stator disc required by the presence of the main drive shaft, on which the appropriate magnetic element (i.e. a thin ring of permanent magnet material or a soft iron strip) would also be mounted.

Thus, two approaches that can assure proper maintenance of the spacing between the rotor and stator discs described herein are described. Either one is suitable for use in a fluid and/or pressured gas environment.

The foregoing description of the invention has been presented for purposes of illustration and description and is not intended to be exhaustive or to limit the invention to the precise form disclosed. Many modifications and variations are possible in light of the above teaching. The embodiments disclosed were meant only to explain the principles of the invention and its practical application to thereby enable others skilled in the art to best use the invention in various embodiments and with various modifications suited to the particular use contemplated. The scope of the invention is to be defined by the following claims.

We claim:

1. An apparatus, comprising:
a central axis;
a first stator fixedly centered on said central axis, wherein said first stator comprises a plurality of first electrodes, wherein said first electrodes are encapsulated in dielectric;
a second stator fixedly centered on said central axis, wherein said second stator comprises a plurality of second electrodes, wherein said second electrodes are encapsulated in dielectric; and
a first rotor centered on said central axis and located between said first stator and said second stator, wherein said first rotor comprises a plurality of first rotor electrodes, wherein said first rotor electrodes are encapsulated in dielectric.

2. The apparatus of claim 1, wherein said first electrodes are encapsulated in dielectric in the form of a first disc, wherein said second electrodes are encapsulated in dielectric in the form of a second disc and wherein said first rotor electrodes are encapsulated in dielectric in the form of a third disc.

3. The apparatus of claim 1, wherein said first electrodes are encapsulated in dielectric in the form of a first cylinder, wherein said second electrodes are encapsulated in dielectric in the form of a second cylinder and wherein said first rotor electrodes are encapsulated in dielectric in the form of a third cylinder.

4. The apparatus of claim 1, wherein said dielectric comprises a polymer.

5. The apparatus of claim 1, wherein each electrode of said first electrodes, said second electrodes and said first rotor electrodes comprises a cross-section that is selected from the group consisting of a circular cross-section and an elliptical cross-section.

6. The apparatus of claim 1, further comprising a containment vessel that contains an insulating liquid or a gas, wherein said first stator, said second stator and said rotor are located in said containment vessel in said insulating liquid or said gas.

7. The apparatus of claim 1, wherein said rotor, said first stator and said second stator are configured such that upon rotation of said rotor, a first gap between said rotor and said first stator and as second gap between said rotor and said second stator changes monotonically.

8. The apparatus of claim 1, further comprising means for centering said rotor, said first stator and said second stator on said central axis.

9. An apparatus, comprising:
a central axis;
a first stator fixedly centered on said central axis, wherein said first stator comprises a plurality of first electrodes, wherein said first electrodes are encapsulated in a dielectric;
a second stator fixedly centered on said central axis, wherein said second stator comprises a plurality of second electrodes, wherein said second electrodes are encapsulated in a dielectric; and
a first rotor centered on said central axis and located between said first stator and said second stator, wherein said first rotor comprises an assembly of dielectric elements, wherein consecutive elements alternate between a relatively high dielectric constant and a low dielectric constant.

10. The apparatus of claim 9, wherein each element of said consecutive element is pie-slice-shaped.

11. The apparatus of claim 9, wherein said first electrodes are encapsulated in dielectric in the form of a first disc and wherein said second electrodes are encapsulated in dielectric in the form of a second disc.

12. The apparatus of claim 9, wherein said first electrodes are encapsulated in dielectric in the form of a first cylinder, wherein said second electrodes are encapsulated in dielectric in the form of a second cylinder and wherein said first rotor is in the form of a third cylinder.

13. The apparatus of claim 9, wherein said dielectric comprises a polymer.

14. The apparatus of claim 9, wherein each electrode of said first electrodes and said second electrodes comprises a cross-section that is selected from the group consisting of a circular cross-section and an elliptical cross-section.

15. The apparatus of claim 9, further comprising a containment vessel that contains an insulating liquid or a gas, wherein said first stator, said second stator and said rotor are located in said containment vessel in said insulating liquid or said gas.

16. The apparatus of claim 9, wherein said rotor, said first stator and said second stator are configured such that upon rotation of said rotor, a first between said first stator and said second stator changes monotonically.

17. The apparatus of claim 9, further comprising means for centering said rotor, said first stator and said second stator on said central axis.

18. The apparatus of claim 9, wherein the periodicity of the alternation of dielectric constant of said dielectric elements is the same as that of said first stator electrodes and said second stator electrodes.
